(19) United States
(12) Patent Application Publication
(10) Pub. No.: US 2011/0157600 A1
(43) Pub. Date: Jun. 30, 2011

(54) OPTICAL WAVE-FRONT RECOVERY FOR ACTIVE AND ADAPTIVE IMAGING CONTROL

(75) Inventor: Richard G. Lyon, Marriottsville, MD (US)

(73) Assignees: USA as represented by the Administrator of the; NASA, Washington, DC (US)

(21) Appl. No.: 12/650,052

(22) Filed: Dec. 30, 2009

(51) Int. Cl. G01B 9/02; G01B 11/00

(52) U.S. Cl. 356/508; 356/521

(57) ABSTRACT

An optical telescope system, method of actively, adaptively providing optical control to an array of articulated mirrors in a sparse aperture in the optical telescope system and a computer program product therefor. Array apertures are selected sequentially for imaging. Each aperture is temporally modulating at a unique/different frequency and, simultaneously, focal plane images are detected for each array aperture with known and separable temporal dependencies. The images are processed for the current set of said focal plane images to detect an image wavefront. The feeding back wavefront errors are fed back to aperture actuators for controlling the array.

### CROSS REFERENCE TO RELATED APPLICATIONS

The present application is related to U.S. patent application Ser. No. 12/198,466, “DIRECT SOLVE IMAGE BASED WAVE-FRONT SENSING” to Lyon, filed Aug. 26, 2008, assigned to the assignee of the present invention.

### ORIGIN OF THE INVENTION

The invention described herein was made by an employee of the United States Government, and may be manufactured and used by or for the Government for governmental purposes without the payment of any royalties thereon or therefor.

### BACKGROUND OF THE INVENTION

1. Field of the Invention

The present invention is generally related to space-based imaging and more particularly to actively, adaptively providing optical control to an array of articulated mirrors in a sparse aperture in an optical system or telescope system

2. Background Description

National Aeronautics and Space Administration (NASA) has been developing interferometric space-based imaging to realize future larger aperture science missions. Imaging interferometers contain an array of multiple telescopes, or apertures, that coherently mix (interferometrically combine) images in a resultant high-resolution image, effectively synthesizing a single aperture. Misaligning the mirrors degrades the image wave-front, blurring or aberating images. Misalignment can even cause multiple images, with severe misalignment causing one per aperture or telescope.

Thus, the ability to sense and control the individual aperture misalignments is paramount to achieving high quality images. Typically, individual misalignments are quantified/encoded as what is known as wave-front error(s). The wave-front errors may be used as feedback control to adjust the mirror positions in what is known as wave-front control. Interferometric missions will require wave-front control onboard with the mirrors.

To that end the NASA Goddard Space Flight Center (NASA/GSFC) has developed the Fizeau Interferometry Testbed (FIT), to study wave-front sensing and control methodologies for future NASA interferometric missions, e.g., the Stellar Imager mission (hires.gsfc.nasa.gov/˜si). The FIT includes from 7-18 articulated mirrors (elements) in a non-redundant Golay pattern that focuses input light into an interferometric white light image. While coarse alignment, dithering combinations of mirrors to eliminate extra images for severe misalignment, may relatively straightforward; finer alignment necessary for high quality imaging requires accurate wave-front sensing and controlling each of the articulated mirrors. Even with such precise control, correctly aligning a number of articulated mirrors with each other can be a long, exhausting, iterative process.

Moreover, feedback control requires first sensing what is wrong, which can be done for optics by using complex metrology systems. Unfortunately, these complex metrology systems frequently introduce errors and do not use the same optical path as the instrument. These prior approaches all require periodically refocusing the system by moving a mirror or by inserting one or more lenses. All of this is time consuming, requires additional hardware, and introduces unknown or errors that also must be calibrated out of the system. Previously, because apertures are aligned to each other, this was a computationally intensive process that required an unacceptably high number of iterations to converge. This problem becomes geometrically/exponentially more complex as the number of apertures increases.

Thus, there is a need for actively, adaptively providing optical control to an array of articulated mirrors in a sparse aperture in an optical system or telescope system

### SUMMARY OF THE INVENTION

It is an aspect of the invention to quickly align articulated mirrors in an array of mirrors;

It is another aspect of the invention to facilitate wave-front sensing and control of articulated mirrors in an array of mirrors;

It is yet another aspect of the invention to minimize the wave-front sensing and control time required to align and simplify control of articulated mirrors in an array of mirrors used in an interferometric imaging system;

It is yet another aspect of the invention to simultaneously recover image wavefronts, while providing active and adaptive optical control feedback to actuators in an optical system or telescope system, and simultaneously recovers the object or extended scene under study in the image.

The present invention relates to an optical telescope system, method of actively, adaptively providing optical control to an array of articulated mirrors in a sparse aperture in the optical telescope system and a computer program product therefor. Array apertures are selected sequentially for imaging. Each aperture is temporally modulating at a unique/different frequency and, simultaneously, focal plane images are detected for each array aperture with known and separable temporal dependencies. The images are processed for the current set of said focal plane images to detect an image wavefront. The feeding back wavefront errors are fed back to aperture actuators for controlling the array.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of application of the present invention in providing remote onboard wave-front sensing and control to quickly align before and, maintain alignment during, science observations and after array reconfigurations in the NASA SI;

FIG. 2 shows a schematic example of the NASA/GSFC Fizeau Interferometry Testbed (FIT) developed for studying wave-front sensing and control methodologies for SI;

FIG. 3 shows a comparison example of an original image and the image recovered using PseudoDiversity after eight (8) time steps;

FIG. 4 shows an example of steps in wavefront resolution, e.g., on the FIT;

FIG. 5 shows image components in each of the 8 time steps (t0-t7) generating the recovered image

### DESCRIPTION OF PREFERRED EMBODIMENTS

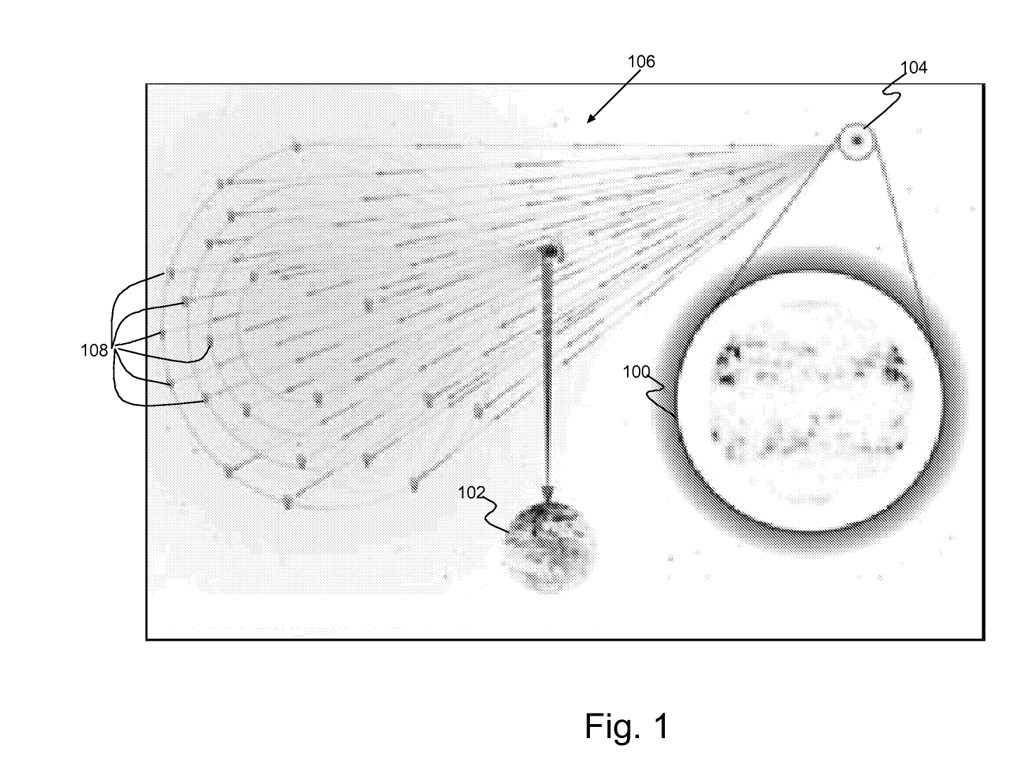

Turning now to the drawings and more particularly FIG. 1 shows an example of a National Aeronautics and Space Administration (NASA) space-based imaging interferometer, e.g., the NASA Stellar Imager (SI). In this example, application of the present invention provides remote onboard wave-front sensing and control to maintain aperture alignment during science observations and after array reconfigurations. SI is an ultraviolet (UV) optical interferometry mission in the NASA Sun-Earth 100, 102 connection, far-horizon roadmap. Such a mission requires both spatial and temporal resolution of stellar magnetic activity patterns 104 that represent a broad range of activity level from stars 106. Studying these magnetic activity patterns 104 enables improved forecasting of solar/stellar magnetic activity as well as an improved understanding of the impact of that magnetic activity on planetary climate and astrobiology. SI, for example, may also allow for measuring internal structure and rotation of the stars 106 using the technique of asteroseismology and relating asteroseismology to the respective stellar dynamos 106.

SI may also image central stars in external solar systems (not shown) and enable an assessment of the impact of stellar activity on the habitability of the planets in those systems. Thus, SI may complement assessments of external solar systems that may be done by planet finding and imaging missions, such as the Space Interferometer Mission (SIM), Terrestrial Planet Finder (TPF) and Planet Imager (PI). SI employs a reconfigurable sparse array of 30 one-meter class spherical mirrors (e.g., 108) in Fizeau mode, i.e., an image plane beam combination. SI has a maximum baseline length up to ˜500 meters, yielding 435 independent spatial frequencies of the image. An earth orbit satellite or other vehicle 109 collects reflected image data and relays the collected information to earth 102.

Presently, imaging interferometry requires sensing path lengths to a fraction of the observing wavelength of light and controlling optical path lengths to a fraction of the coherence length, i.e., λ²/Δλ=λR. For example, λ=1550 Angstroms (1550 Å) at a spectral resolution R=100 implies sensing to λ/10=155 Å and effective control to <15.5 microns (15.5 μ) in direct imaging mode provided tip/tilt per sub-aperture is corrected to better than 1.22λ/D=40 milli-arcseconds (mas) at the shortest wavelength. NASA Goddard Space Flight Center (NASA/GSFC) developed the Fizeau Interferometry Testbed (FIT) to study wave-front sensing and control methodologies for SI and other large, interferometric telescope systems.

Wavefront errors can cause segment misalignment and deformation errors. Conventional phase retrieval and phase diversity approaches introduce one or more artificial, but known, phase errors (typically focus) and apply iterative, nonlinear algorithms to solve for these wavefront errors. Prior approaches either used what is known as metrology employing a separate alignment instrument or, what is known as Phase Retrieval for a point (or known) source in combination with Phase Diversity for an extended source. The Hubble Space Telescope, for example, used phase retrieval. Originally, phase retrieval was also proposed for the James Webb Space Telescope.

Both phase retrieval and phase diversity require a defocussed narrowband image of an unresolved point source. Moreover, these prior phase retrieval and phase diversity techniques require periodically refocussing the system by moving a mirror or by the insertion of one or more lenses. Either way, refocussing takes time, requires more hardware, and introduces unknowns and/or errors into results that must be calibrated out of the system.

Typical conventional algorithms used to remove these errors are non-linear, iterative approaches that are computationally time consuming. These conventional non-linear algorithms have had problems with convergence and stagnation, and are temporally non-deterministic. Consequently, it may be impossible to predict prior to execution how many iterations these conventional algorithms take to converge.

By contrast wavefront resolution according to a preferred embodiment of the present invention (referred to herein as PseudoDiversity) avoids these limitations. In particular, preferred wavefront resolution uses temporally diverse extended scene images to solve for misalignment and deformation of the optics from focal plane images, simultaneously providing a high resolution estimation of the object.

PseudoDiversity uses the same optical path as a target under study without requiring extraneous hardware. Thus, PseudoDiversity avoids introducing non-common path errors. Moreover, PseudoDiversity can use either the natural temporal drift from system vibration or jitter or from atmospheric turbulence. Alternatively, PseudoDiversity can use any conventional modulation schemes. Furthermore, PseudoDiversity has application to any segmented, sparse or interferometric aperture system, regardless of whether the aperture is redundant or non-redundant.

For a non-redundant aperture the preferred algorithm is a direct solve image-based wavefront sensing algorithm, such as described, for example, in U.S. patent application Ser. No. 12/198,466 entitled “DIRECT SOLVE IMAGE BASED WAVE-FRONT SENSING” to Lyon, filed Aug. 26, 2008, assigned to the assignee of the present invention and incorporated herein by reference. For a redundant aperture any suitable iterative approach may be employed, such as for example, Lyon et al, “Hubble Space Telescope Faint Object Camera Calculated Point Spread Functions,” Applied Optics, Vol. 36, No. 8, Mar. 10, 1997, or Lyon et al, “Extrapolating HST Lessons to NGST (now JWST),” Optics and Photonics News, July 1998. For purposes of description, the present invention is described herein with application to a non-redundant aperture using direct solve image-based wavefront sensing.

Every wavefront may be described as having two components, a static and a dynamic component. The static wavefront component is related to fixed errors in the optics and to the phases of the object. The dynamic wavefront component is related to time dependent optical errors and to atmospheric turbulence and/or other time varying induced errors. Usually, neither component is known and both must be determined for controlling the apertures.

Every image has spatial, temporal and spectral correlations. PseudoDiversity exploits these correlations as a function of time to build phase corrected spatial frequencies of the image. The static component of any imaged object is not time varying and does not change; or only changes so slowly with respect to the imaging time that it may, therefore, be considered effectively as unchanging during in the imaging period. Integrating phase corrected spatial frequencies, simultaneously recovers both the high resolution object and wavefront errors. Feeding the wavefront errors back to control aperture actuators exploits the static nature of the imaged object in controlling the apertures.

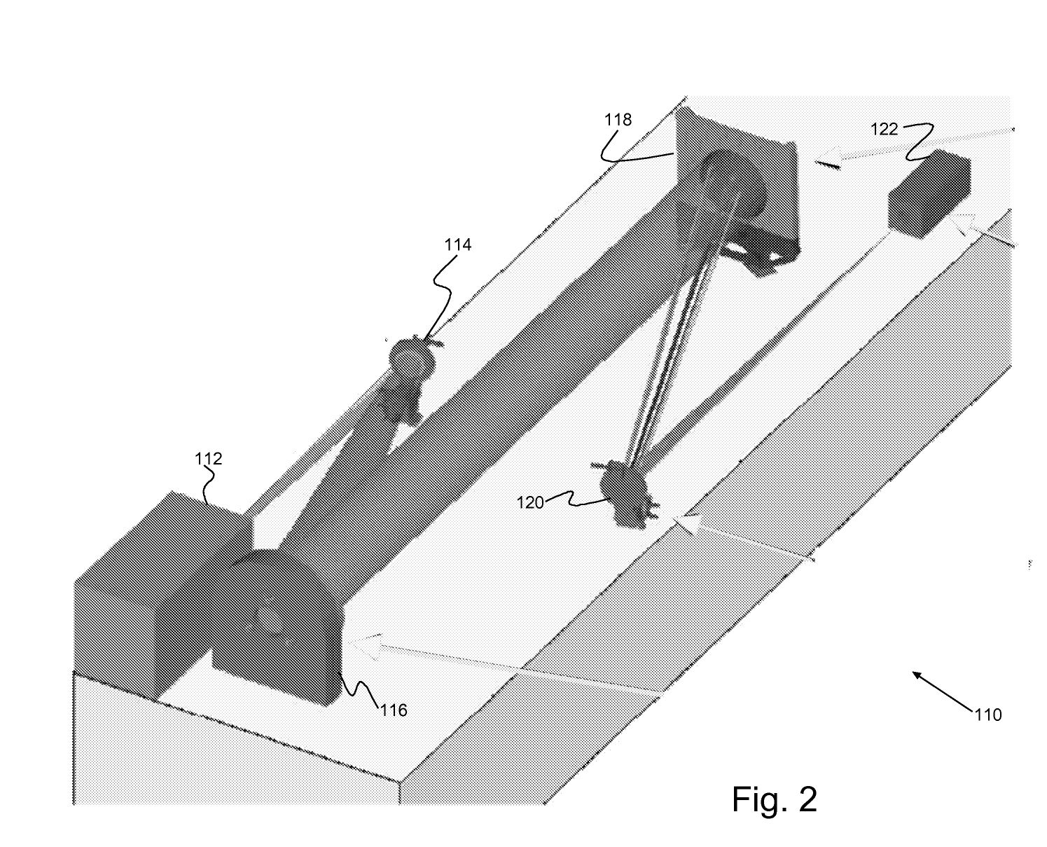

FIG. 2 shows a schematic example of the FIT 110, which includes in this example a light source 112 directing light at a hyperboloidal secondary mirror 114. The hyperboloidal secondary mirror 114 reflects and redirects the light to an off-axis parabola (OAP) collimator 116 or OAP. Collimated light from the OAP 116 is directed to interferometric mirror array 118. Light reflected from the interferometric mirror array 118 is redirected by an elliptical secondary mirror 120 to focal 122, where the light from the individual mirrors 118 combine interferometrically into the resultant image.

Wavefront resolution may be applied to the FIT 110 using PseudoDiversity to actively, adaptively providing optical control the FIT 110 according to a preferred embodiment of the present invention. Initially, the FIT 110 was designed to operate at optical wavelengths using a minimum-redundancy array for segments of the primary mirror 118. Light from the source assembly 112 can illuminate an extended-scene film located in the front focal plane of the collimator mirror assembly, which includes the hyperboloid secondary mirror 114 and the off-axis paraboloid primary 116. The elements of the primary mirror array 118 are each positioned to intercept the collimated light, and relay it to the oblate ellipsoid secondary mirror 120, which subsequently focuses relayed light onto the image focal plane 122.

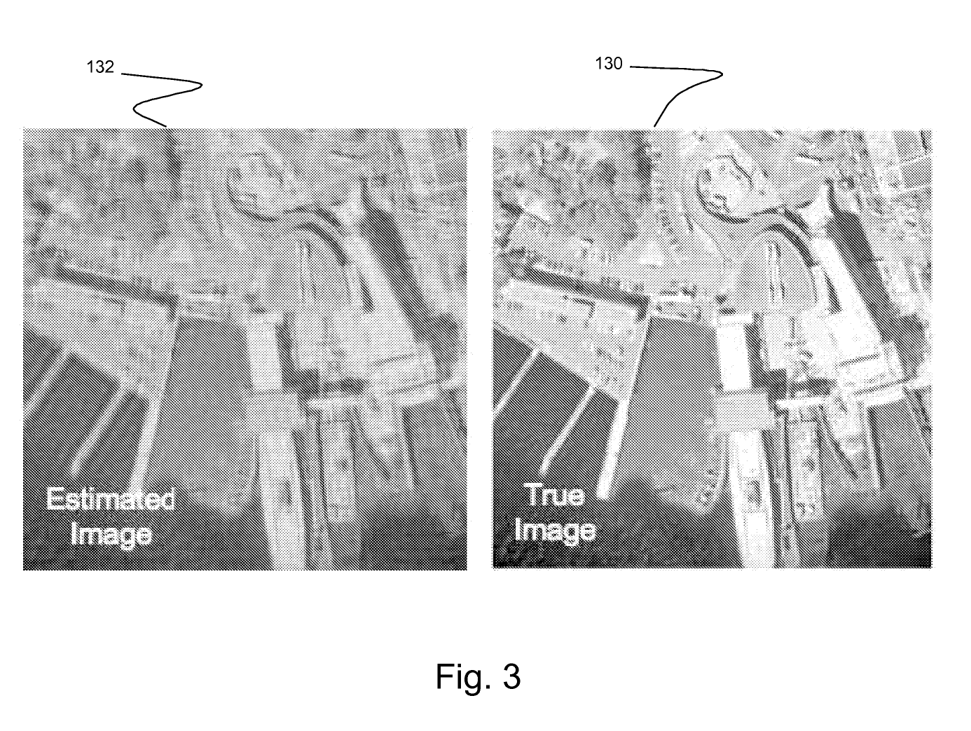

FIG. 3 shows a comparison example of an original image 130 and the image 132 after eight (8) time steps, recovered using PseudoDiversityto simultaneously recover image wavefronts, while recovering the object or extended scene under study in the image. Although the result 130 is not of the same quality as the original image, PseudoDiversity improves recovered image 132 quality with each time step. As shown hereinbelow, segment alignment accuracy and precision of aperture segments improves with each iteration in a state of the art segmented and sparse/interferometric optical system. So in particular, PseudoDiversity has application to improving image quality in any segmented optical system that includes a set of N segments or apertures, wherein a subset of the apertures may be temporally modulated.

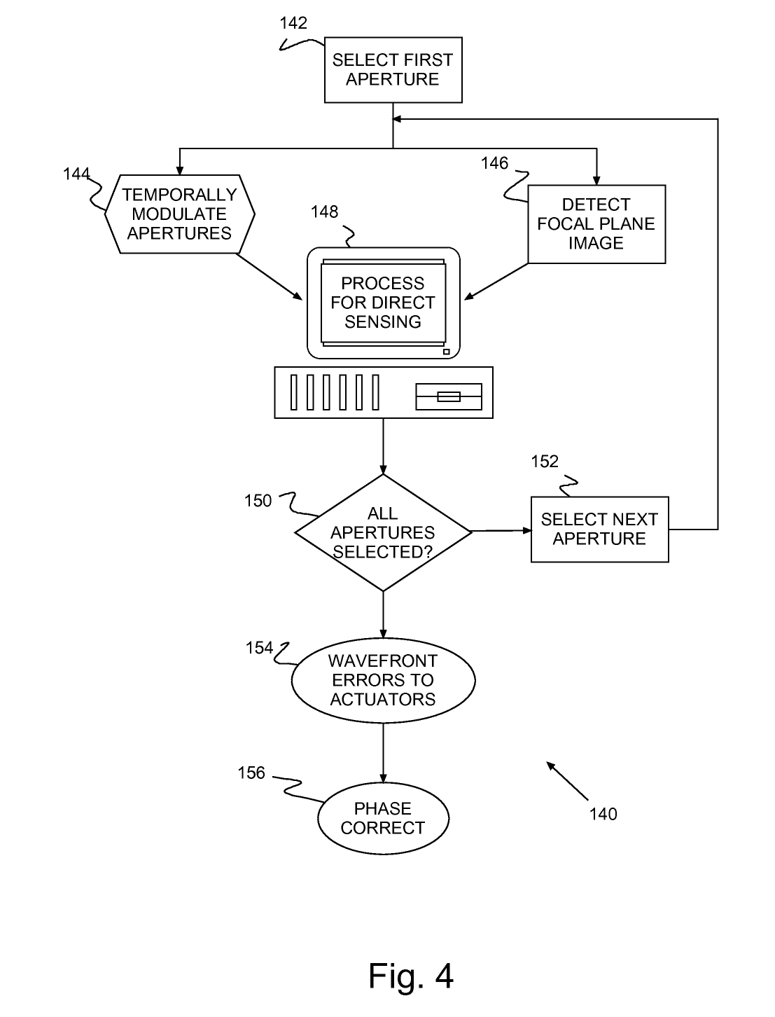

FIG. 4 shows an example of steps in wavefront resolution 140, e.g., on the FIT 110, according to a preferred embodiment of the present invention. A first iteration begins in step 142, selecting each aperture and modulating 144 each temporally at a different frequency. Simultaneously with modulation step 144, focal plane images are sequentially detected 146 with known and separable temporal dependencies. The current set of images are processed 148 after each iteration to allow for direct sensing, e.g., using a direct solve image-based wavefront sensing algorithm. This direct sensing determines piston, tip and tilt errors over each of the segments or sub-apertures of the imaging interferometer. If all of the apertures have not been selected 150, the next aperture is selected 152 and modulated 144. Once these wavefront errors are known, in step 154 the errors are fed back to actuators. Any errors that the actuators do not accurately correct are passed for image phase correction 156, algorithmically. So, running in closed-loop, the preferred optical system simultaneously maintains high image quality while controlling the optical system. Thus, the present invention has application to high bandwidth and photon starved applications and works on broadband extended images.

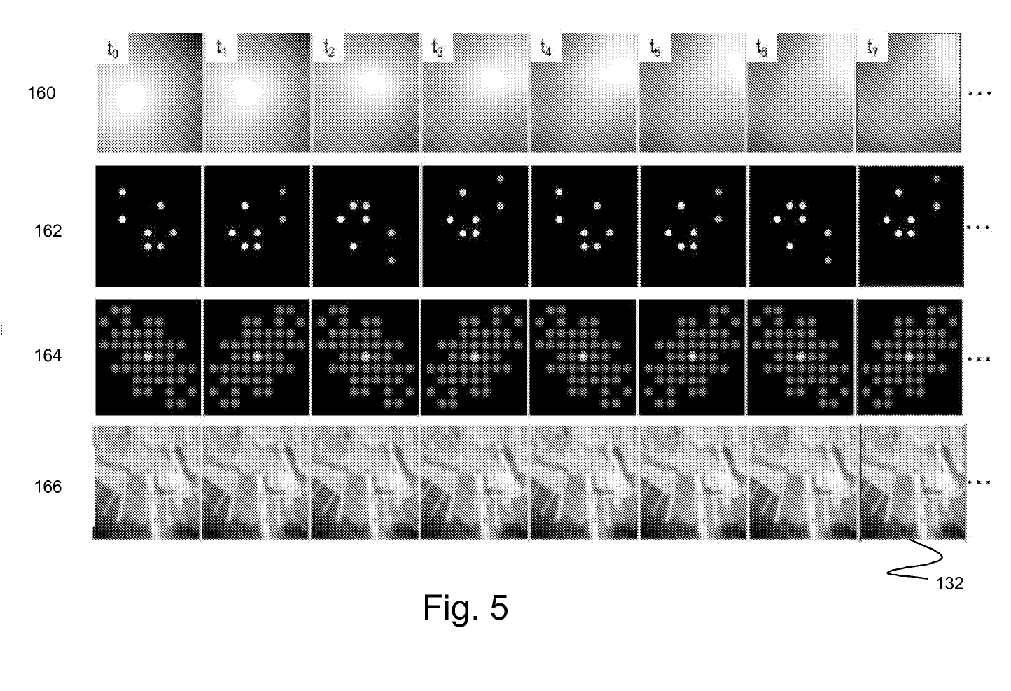

FIG. 5 shows image components 160, 162, 164 and 166 in each of 8 time steps (t0-t7) generating the recovered image 132 of FIG. 3B. Atmospheric turbulence wavefront error 160 is shown as Kolmogorov phase turbulence dithering (σ) a subset of sub-apertures in piston only through a small range of +/−½ the wavelength of the light, i.e., λ/2 at each time step. Instantaneous phase error 162 is shown for a Phase X non-redundant Golay-7 aperture pattern at each time step. The instantaneous spatial frequency response at each time step is shown in the Modulation Transfer Function (MTF) 164 for the aperture pattern. Finally, the collected camera images 166 show very little degradation from turbulence with a Signal to Noise Ratio (SNR) of 200. Of course, these instantaneous images are of lower resolution than if there was no turbulence.

Advantageously, PseudoDiversity uses the system as it is and does not require defocusing of the system or adding other lens, or mirrors. So, PseudoDiversity does not require extraneous hardware. Instead, PseudoDiversity proceeds by dithering a subset of sub-apertures in piston only through a small range of +/−½ the wavelength of the light, and collecting at least 4 images per piston dither period. This requires only a capability for actuating the pistons that move segments (or interferometric sub-apertures) in and out, tip and tilt and that an imaging detector exists at the focal plane of the particular instrument.

Furthermore, processing images through PseudoDiversity allows for direct recovery of piston, tip and tilt of each segment or sub-aperture, working in image's spatial Fourier domain. The image is phase corrected in its spatial Fourier domain and inverse transformed back to the spatial domain at each time step and summed with all the previous time steps resulting in a high signal-to-noise ratio image. Thus, PseudoDiversity uses the instrument's own optical path all the way through to the detector, i.e., the same optical path as the target under study. This avoids introducing non-common path errors.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of active, adaptive optical control of an array of mirrors in a sparse aperture telescope system, said method comprising the steps of:
a) selecting a first aperture in an array of mirrors;
b) temporally modulating each aperture at a different frequency;
c) sequentially detecting focal plane images with known and separable temporal dependencies;
d) processing a current set of images to detect an image wavefront;
e) selecting a next aperture in said array of mirrors; and
f) returning to step (b) until all apertures have been selected.

2. A method as in claim 1, wherein the step (b) of temporally modulating apertures and step (c) of sequentially detecting focal plane images are simultaneous.

3. A method as in claim 2, after all apertures have been selected further comprising providing wavefront errors to aperture actuators.

4. A method as in claim 1, wherein an image is recovered simultaneously with recovering the image wavefront.

5. A method as in claim 1, wherein said array comprises non-redundant apertures and the processing step (d) comprises direct solve image-based wavefront sensing.

6. A method as in claim 1, after all apertures have been selected further comprising providing wavefront errors to aperture actuators.

7. A method as in claim 6, further comprising passing for image phase correction any errors that the actuators do not accurately correct.

8. A computer program product for actively, adaptively optically controlling an array of mirrors, said computer program product comprising a computer usable medium having computer readable program code stored thereon comprising:
computer readable program code means for selecting apertures in an array of mirrors;
computer readable program code means for modulating each array aperture temporally at a different frequency;
computer readable program code means for sequentially detecting focal plane images with known and separable temporal dependencies for said each array aperture; and
computer readable program code means for processing a current set of said focal plane images to detect an image wavefront.

9. A computer program product for aligning an array of mirrors as in claim 7, wherein the computer readable program code means for sequentially detecting focal plane images detects said focal plane images simultaneously with said each array aperture being temporally modulated.

10. A computer program product for aligning an array of mirrors as in claim 7, wherein the computer readable program code means for selecting apertures sequentially selects each apertures.

11. A computer program product for aligning an array of mirrors as in claim 10, wherein the computer readable program code means for processing processes said current set of images to detect an image wavefront for each selected apertures.

12. A computer program product for aligning an array of mirrors as in claim 11, wherein the computer readable program code means for processing said current set of images comprises computer readable program code means for direct solve image-based wavefront sensing.

13. A computer program product for aligning an array of mirrors as in claim 7, further comprising computer readable program code means for feeding back wavefront errors to aperture actuators.

14. A computer program product for aligning an array of mirrors as in claim 13, further comprising computer readable program code means for passing for image phase correction any errors that the actuators do not accurately correct.

15. An optical telescope system comprising:
an array of articulated mirrors in a sparse aperture;
means for sequentially selecting apertures in said array;
means for modulating each aperture temporally at a different frequency;
means for sequentially detecting focal plane images with known and separable temporal dependencies for said each array aperture; and
means for processing a current set of said focal plane images to detect an image wavefront.

16. An optical telescope system as in claim 15, wherein the means for sequentially detecting focal plane images detects said focal plane images simultaneously with said each array aperture being temporally modulated.

17. An optical telescope system as in claim 15, wherein the means for selecting apertures sequentially selects each apertures.

18. An optical telescope system as in claim 17, wherein the means for processing processes said current set of images to detect an image wavefront for each selected apertures.

19. An optical telescope system as in claim 18, wherein the means for processing said current set of images comprises means for direct solve image-based wavefront sensing.

20. An optical telescope system as in claim 15, further comprising means for feeding back wavefront errors to aperture actuators for actively, adaptively optically controlling said array of articulated mirrors.

21. An optical telescope system as in claim 20, further comprising means for passing for image phase correction any errors that the actuators do not accurately correct.
